(19) United States
(12) Patent Application Publication
(10) Pub. No.: US 2022/0090739 A1
(43) Pub. Date: Mar. 24, 2022

(54) HYBRID REFUELING STATION AND METHOD FOR REFUELING

(71) Applicants: China Energy Investment Corporation Limited, Beijing (CN); National Institute of Clean-and-Low-Carbon Energy, Beijing (CN)

(72) Inventors: Jerad Allen Stager, Richmond, CA (US); Xianming Li, Orefield, PA (US); Anthony Ku, Fremont, CA (US); Edward Youn, Pacific Grove, CA (US)

(21) Appl. No.: 17/027,704

(22) Filed: Sep. 21, 2020

(51) Int. Cl. F17C 5/04; F17C 7/04

(52) U.S. Cl. CPC F17C 5/04; F17C 7/04; F17C 2221/012; F17C 2221/035; F17C 2270/0139; F17C 2223/0161; F17C 2227/015; F17C 2227/0393; F17C 2221/033

(57) ABSTRACT

Provided is a hybrid refueling station, including: a liquefied fuel unit, a gaseous fuel unit, a temperature management system and a dispensing unit. By combining the liquefied fuel unit with the gaseous fuel unit, boil-off fuel from the liquefied fuel unit is recovered into the gaseous fuel unit, which avoids boil-off loss of liquefied fuel. Provided also is a method for refueling in a hybrid refueling station. By using the gaseous fuel unit to perform a refueling operation during start-up of the liquefied fuel unit, the problem in the prior art of a delay during start-up when the liquefied fuel unit is used is overcome.

### FIELD OF THE INVENTION

The present disclosure relates to the technical field of clean energy, and in particular, to a hybrid refueling station and a method for refueling.

### BACKGROUND OF THE INVENTION

A hydrogen-fuel vehicle is a vehicle which uses hydrogen as the main energy for movement. The product of reaction using hydrogen as fuel is water, which does not pollute the environment and is clean. At present, the technology of vehicle-mounted high-pressure gas storage tank has become mature and has high safety. The time of hydrogen dispensing is about the same as the time of dispensing for a gasoline or diesel vehicle, and it is generally required that hydrogen dispensing be carried out in a hydrogen refueling station.

Hydrogen refueling stations can be developed according to the following several designs.

1. Compressed gas storage, wherein the hydrogen is further compressed and stored at high pressure in buffer/cascade storage tubes before being refrigerated and dispensed to a vehicle. This design requires a compression and refrigeration system, which dominates the cost and energy use, and also limits the capacity of the hydrogen refueling station to do back-to-back dispensing. A detailed structure can be seen in FIG. 1.

2. Compressed gas storage, wherein the hydrogen is stored at intermediate pressure in buffer/cascade storage tubes after being further pressurized using a booster compressor and cooled using a refrigeration system and before being dispensed to the vehicle. This design has similar limitations to the above design, and a detailed structure can also be seen in FIG. 1.

3. Liquefied hydrogen fuel storage, wherein liquid hydrogen fuel is vaporized, compressed and stored at high pressure in buffer/cascade storage tubes before being refrigerated and dispensed to a vehicle (FIG. 2). This design offers a higher storage capability than design (1), since the higher density of the liquid hydrogen fuel can allow a smaller footprint for tank storage relative to gaseous hydrogen fuel. A drawback of liquid hydrogen fuel storage is boil-off loss of the liquid hydrogen fuel. In particular, heat leak into the storage tank results in vaporization of a portion of the liquid hydrogen fuel. Hence, this gas is unsuitable for dispensing as fuel without the installation of compressors and other equipment to condition the temperature and pressure to appropriate levels.

4. Liquid hydrogen fuel storage, wherein the liquid hydrogen fuel is vaporized at high pressure and dispensed to the vehicle using a cryopump (also in FIG. 2). This approach offers the potential for a simplified design, but does not eliminate the problem associated with boil-off loss. In this design, a cryo-pump positioned outside of the liquid storage tank must undergo precooling cycle before it starts up. This process can take up to 15 minutes and results in a delay in start-up of refueling. This delay is much shorter (or eliminated) in back-to-back dispensing situations, when the system is already cooled.

U.S. Pat. No. 8,069,885 discloses a mobile hydrogen refueling station with a liquid hydrogen fuel storage tank that can dispense liquid hydrogen fuel via a pump, or dispense gaseous hydrogen fuel via a vaporizer, a compressor, cascade, etc. Overhead boil-off gas of the liquid hydrogen fuel storage tank as well as gas in the cascade storage is used for a fuel cell which provides power for system control, the compressor and the pump. The hydrogen refueling station is self-sufficient and does not need external power supply. However, adding a fuel cell further complicates the station setup and increases capital cost, and being self-sufficient is not necessary for commercial scale stations.

U.S. Pat. No. 5,243,821 discloses a direct drive reciprocating machine where the inlet fluid can be either liquid, gas, or a mixture. It includes a blowby recovery circuit, an internal recirculation unit to control the flow rate. The blowby may be bubbled through the liquid bath in the storage tank to reduce stratification in the storage tank. The use of vapor space gas reduces vent loss, and allows the vaporized gas to be used during start-up. Although this process recovers the boil-off gas, the initial flow rate is very small because the vaporized gas is compressed, and the flow rate is too low for commercial scale stations.

Hence, there is a need to develop a refueling station at commercial scale that minimizes equipment size, captures boil-off fuel, and eliminates delay during start-up for back-to-back refueling, so as to overcome the problems existing in the prior art.

### SUMMARY OF THE INVENTION

In order to solve the existing problems including large volume of the refueling station, inadequate use of the liquefied fuel and a long delay during start-up, the present disclosure provides a hybrid refueling station, so as to achieve effects of reducing the equipment size, adequately using the liquefied fuel and shortening the start-up time.

The present disclosure provides a hybrid refueling station, including:

a liquefied fuel unit, which includes at least one liquefied fuel storage device, a vaporization device and a first gas storage subunit, wherein the liquefied fuel storage device is connected with the first gas storage subunit via the vaporization device, and the first gas storage subunit is used for storing vaporized fuel;

a gaseous fuel unit, which includes at least one gaseous fuel storage device, a pressurization device and a second gas storage subunit, wherein the gaseous fuel storage device is connected with the second gas storage subunit via the pressurization device, and the second gas storage subunit is used for storing pressurized gaseous fuel;

a temperature management system, which includes a gas inlet and a gas outlet, wherein the gas inlet is connected to the liquefied fuel unit and the gaseous fuel unit respectively for adjusting a temperature of gas discharged from the liquefied fuel unit and the gaseous fuel unit; and

a dispensing unit, which is connected to the gas outlet of the temperature management system for dispensing gas from the temperature management system,

wherein boil-off fuel from the liquefied fuel unit is recovered to the gaseous fuel unit, preferably to the gaseous fuel storage device, and the boil-off fuel preferably includes boil-off fuel from the liquefied fuel storage device and boil-off fuel during cryopump precooling.

It should be noted that the boil-off fuel is the fuel that vaporizes naturally from the liquefied fuel unit and does not undergo vaporization by the vaporization device.

By using devices in the present disclosure, the dispensing unit may choose to acquire fuel from the liquefied fuel unit or the gaseous fuel unit for dispensing according to refueling needs of vehicles. Besides, a utilization rate of the liquefied fuel is further improved by recovering the boil-off fuel from the liquefied fuel unit to the gaseous fuel storage device.

In some embodiments, the temperature management system further includes a heat exchanger inlet and a heat exchanger outlet, wherein the heat exchanger inlet is connected to the liquefied fuel unit, and the heat exchanger outlet is connected to the gaseous fuel unit, preferably to the gaseous fuel storage device or the second gas storage subunit.

During stable operating, the liquefied fuel in the liquefied fuel storage device may be used for heat-exchanging to the temperature management system. The liquefied fuel after the heat-exchanging is vaporized because of change in the temperature, and the vaporized fuel may be cycled to the gaseous fuel unit for providing a supplement to the gaseous fuel unit.

In some embodiments, the gaseous fuel storage device is used to receive gaseous fuel from at least one of fuel delivery or on-site generation.

The liquefied fuel unit further includes a low-temperature pressurization device, wherein a feeding end of the low-temperature pressurization device is connected to an outlet of the liquefied fuel storage device, and a discharging end of the low-temperature pressurization device is connected to an inlet of the vaporization device, wherein the low-temperature pressurization device is preferably a cryopump.

In some specific embodiments, the first gas storage subunit is selected from the group consisting of a cascade storage tubes or a buffer storage tank.

In some specific embodiments, the second gas storage subunit is selected from the group consisting of a cascade storage tubes or a buffer storage tank.

In some specific embodiments, the temperature management system is a refrigeration device, preferably selected from the group consisting of a tubular heat exchanger, a coil heat exchanger and a plate heat exchanger.

In some specific embodiments, the dispensing unit includes a refueling nozzle for performing a refueling operation to vehicles.

In some specific embodiments, the pressurization device is a gas compressor, and the vaporization device is a vaporizer.

According to another aspect of the present disclosure, a method for refueling by using the hybrid refueling station is provided, which includes:

refueling, during start-up of a liquefied fuel unit, by a gaseous fuel unit and recovering boil-off fuel from the liquefied fuel unit to the gaseous fuel unit, preferably to a gaseous fuel storage device, wherein the boil-off fuel preferably includes boil-off fuel from a liquefied fuel storage device and boil-off fuel during cryopump precooling.

Specifically, during start-up of the liquefied fuel unit, the gaseous fuel unit is used for performing a refueling operation. At this time, liquefied fuel vaporizes and supplies refrigeration, and boil-off fuel is cycled to the gaseous fuel unit and is stored for use. Hence, a delay during start-up resulted from inadequate refrigeration is overcome, and meanwhile the boil-off fuel during start-up of a system is used effectively.

In some embodiments, a step of refueling by the gaseous fuel unit includes: performing refueling after subjecting gaseous fuel in the gaseous fuel storage device to pressurization by a gas compressor and introducing compressed gaseous fuel to the second gas storage subunit.

Specifically, refueling by the gaseous fuel unit may be carried out by directly subjecting gaseous fuel in the second gas storage device to heat-exchanging and feeding obtained gaseous fuel to the dispensing unit for dispersing, or by directly subjecting gaseous fuel in the gaseous fuel storage device to pressurization and heat-exchanging and feeding obtained gaseous fuel to the dispensing unit for dispersing.

In some embodiments, the method for refueling by using the hybrid refueling station further includes: performing refueling by the gaseous fuel unit or the liquefied fuel unit after start-up of the liquefied fuel unit is finished.

In some embodiments, a step of refueling by the liquefied fuel unit includes: subjecting liquefied fuel in the liquefied fuel storage device to pressurization by a cryopump; and introducing one portion of pressurized liquefied fuel to a vaporization device for vaporization and storing vaporized fuel in the first gaseous storage subunit for refueling, and delivering the other portion of pressurized liquefied fuel to the temperature management system for heat-exchanging and cycling the liquefied fuel after the heat-exchanging to the gaseous fuel unit as a supplement.

Specifically, after start-up of the liquefied fuel unit is finished, dispensing is carried out by subjecting the gaseous fuel in the second gas storage subunit to heat-exchanging and delivering obtained gaseous fuel to the dispensing unit, or by subjecting the gaseous fuel in the first gas storage subunit to heat-exchanging and delivering obtained gaseous fuel to the dispensing unit, or by subjecting the liquefied fuel in the liquefied fuel storage device to vaporization and heat-exchanging and delivering obtained gaseous fuel to the dispensing unit, or by subjecting the gaseous fuel in gaseous fuel storage device to pressurization and heat-exchanging and delivering obtained gaseous fuel to the dispensing unit.

In some embodiments, the liquefied fuel from the liquefied fuel unit is used to perform refrigeration to the temperature management system.

In some specific embodiments, the fuel is selected from hydrogen, natural gas, propane, or other commonly used fuel or derivatives thereof.

Compared with the prior art, the present disclosure combines the liquefied fuel unit and the gaseous fuel unit and uses the gaseous fuel unit for refueling during start-up of the liquefied fuel unit, thereby overcoming the problem in the prior art of the delay during start-up when the liquefied fuel unit is used; and meanwhile the boil-off fuel from the liquefied fuel unit is recovered to the gaseous fuel unit, thereby avoiding boil-off loss of the liquefied fuel. By utilizing respective advantages of the liquefied fuel and the gaseous fuel, the hybrid refueling station according to the present disclosure has a significantly reduced equipment size compared with a refueling station which uses the gaseous fuel to reach a target refueling capacity/capability, has an obviously reduced boil-off loss compared with using the liquefied fuel for refueling, and meanwhile eliminates the delay during start-up associated with performing cryogenic pressurization by a liquefied fuel unit with a cryogenic pressurization device.

### BRIEF DESCRIPTION OF THE DRAWINGS

The scope of the present disclosure will be better understood by reading the detailed description of the illustrative embodiments below with reference to the accompanying drawings, in which:

FIG. 1 schematically shows a structure of a gaseous fuel refueling station in the prior art;

FIG. 2 schematically shows a structure of a liquefied fuel refueling station in the prior art;

and

FIG. 3 schematically shows a structure of a hybrid refueling station according to Embodiment 1 of the present disclosure;

FIG. 4 schematically shows a structure of a hybrid refueling station according to Embodiment 2 of the present disclosure;

FIG. 5 shows a functional relation between a total dispensing cost (in $/kg) and a refueling station size (in kg/d) according to the present disclosure; and

FIG. 6 shows a functional relation between a total capital cost (in $) and a refueling station size (in kg/d) of the refueling station according to the present disclosure.

### LIST OF REFERENCE NUMBERS

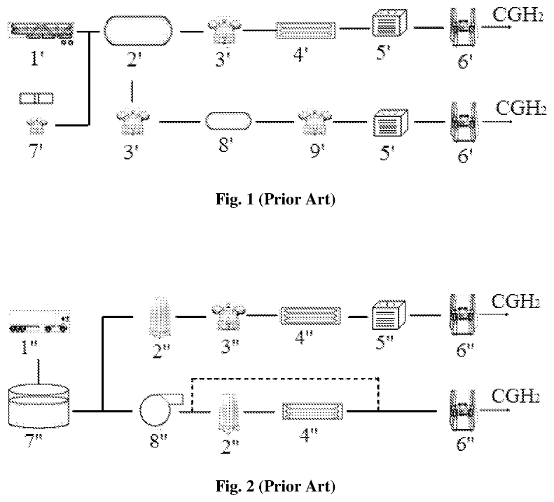

In FIG. 1, 1′—trailer; 2′—low pressure storage tank; 3′—gas compressor; 4′—cascade tubes/buffer storage tank; 5′—refrigerator; 6′—dispenser; 7′—electrolysis+compression device; 8′—intermediate pressure storage tank; 9′—booster compressor;

In FIG. 2, 1″—liquefied fuel trailer; 2″—vaporizer; 3″—gas compressor; 4″—cascade tubes/buffer storage tank; 5″—refrigerator; 6″—dispenser; 7″—liquefied hydrogen fuel storage tank; 8″—liquefied fuel low-temperature pump (cryopump);

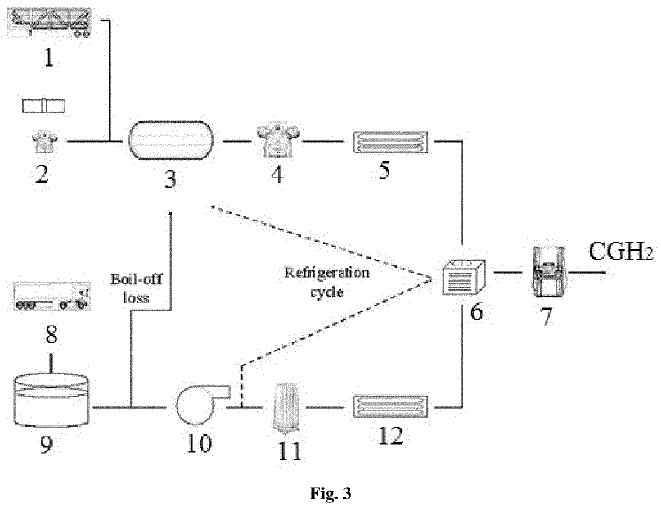

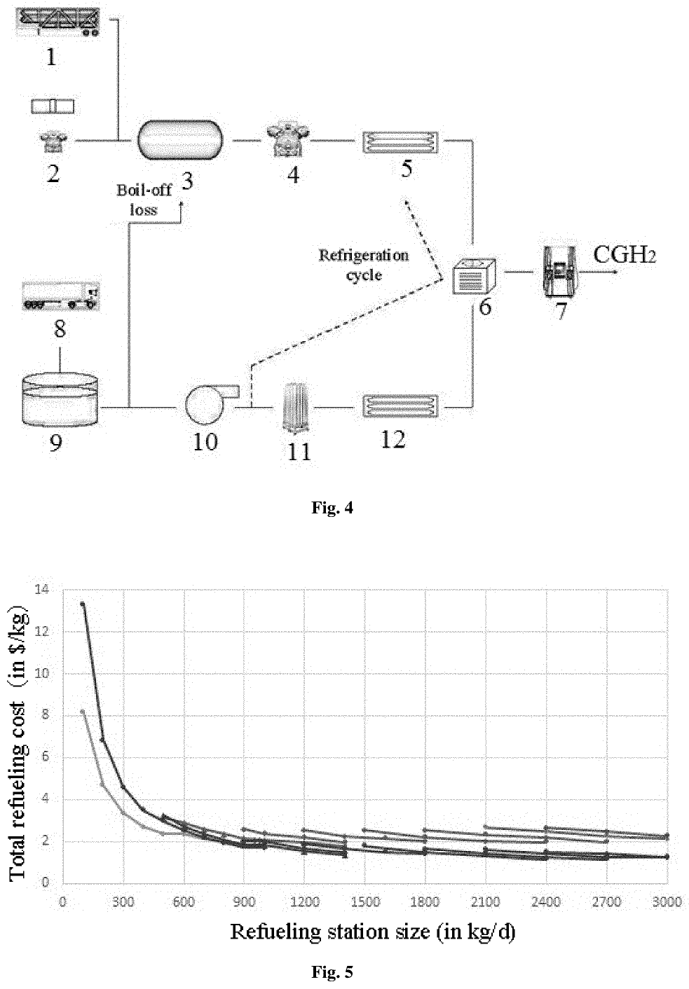

In FIG. 3 and FIG. 4, 1—trailer; 2—electrolysis+compression device; 3—gaseous fuel storage device; 4—gas compressor; 5—second gas storage subunit; 6—temperature management system; 7 dispensing unit; 8—liquefied fuel trailer; 9—liquefied fuel storage device; 10—cryopump; 11—vaporization device; 12—first gas storage subunit.

### DETAILED DESCRIPTION OF THE EMBODIMENTS

Technical solutions in embodiments of the present disclosure will be illustrated clearly and completely hereinafter in combination with the accompanying drawings of the embodiments to make the purpose and advantages of the present disclosure more clear. Obviously, embodiments to be described are only some embodiments of the present disclosure, rather than all embodiments of the present disclosure.

Hence, the detailed description of the embodiments of the present disclosure with reference to the accompanying drawings is not intended for limiting the claimed scope of the present disclosure, but only provides preferred embodiments of the present disclosure. All other embodiments obtained by those ordinary skilled in the art without making any creative effort based on the embodiments of the present disclosure fall into the protection scope of the present disclosure.

Referring to FIG. 3 and FIG. 4, a hybrid refueling station is provided in embodiments of the present disclosure. The hybrid refueling station includes:

a liquefied fuel unit, which includes a liquefied fuel storage device 9, a low-temperature pressurization device 10, a vaporization device 11 and a first gas storage subunit 12, wherein an outlet of the liquefied fuel storage device 9 is connected to a feeding end of the low-temperature pressurization device 10 and a gaseous fuel storage device 3 respectively, a discharging end of the low-temperature pressurization device 10 being connected to an inlet of the vaporization device 11, an outlet of the vaporization device 11 being connected to a feeding end of the first gas storage subunit 12, and a discharging end of the first gas storage subunit 12 being connected to a gas inlet of a temperature management system 6, wherein the low-temperature pressurization device 10 is a cryopump;

a gaseous fuel unit, which includes the gaseous fuel storage device 3, a pressurization device 4 and a second gas storage subunit 5, wherein an outlet of the gaseous fuel storage device 3 is connected to a feeding end of the pressurization device 4, a discharging end of the pressurization device 4 being connected to an inlet of the second gas storage subunit 5, and a discharging end of the second gas storage subunit 5 being connected to the gas inlet of the temperature management system 6, wherein the pressurization device 4 is a gas compressor;

the temperature management system 6, which includes a heat exchanger inlet, a heat exchanger outlet, a gas inlet and a gas outlet, wherein the gas inlet is connected to the first gas storage subunit 12 of the liquefied fuel unit and the second gas storage subunit 5 of the gaseous fuel unit respectively, for adjusting a temperature of gas from the liquefied fuel unit and the gaseous fuel unit; and

a dispensing unit 7, wherein a gas outlet of the temperature management system 6 is connected to an inlet of the dispensing unit, an outlet of the dispensing unit is connected to a vehicle to be refueled.

A process for using the hybrid refueling station for refueling is specifically as follows:

When a vehicle enters the refueling station, the liquefied fuel unit and the gaseous fuel unit in the refueling station start up at the same time; the low-temperature pressurization device 10 starts a refrigeration cycle; the pressurization device 4 pressurizes gas from the gaseous fuel storage device 3; pressurized gas goes through the second gas storage subunit 5 and enters the temperature management system 6 for cooling; cooled gaseous fuel is dispensed to a vehicle by the dispensing unit 7. After precooling of the low-temperature pressurization device 10 is finished, liquefied fuel from the liquefied fuel storage device 9 is pressurized by the low-temperature pressurization device 10 and is vaporized into gaseous fuel by the vaporization device 11, and the gaseous fuel is stored in the first gas storage subunit 12 for use; and meanwhile, boil-off fuel in the refrigeration cycle is recovered to the gaseous fuel storage device 3 as a supplement. After start-up of the liquefied fuel unit is finished, when a vehicle enters the refueling station, dispensing may be carried out by subjecting the gaseous fuel in the second gas storage subunit 5 to heat-exchanging and delivering obtained gaseous fuel to the dispensing unit 7, by subjecting the gaseous fuel in the first gas storage subunit 12 to heat-exchanging and delivering obtained gaseous fuel to the dispensing unit 7, by subjecting the liquefied fuel in the liquefied fuel storage device 9 to low-pressure pressurization, vaporization and heat-exchanging and delivering obtained gaseous fuel to the dispensing unit 7, or by subjecting the gaseous fuel in gaseous fuel storage device 3 to pressurization and heat-exchanging and delivering obtained gaseous fuel to the dispensing unit 7, so as to accomplish back-to-back refueling operations for vehicles. When there is a shortage of fuel storage in the gaseous fuel storage device 3, the fuel may be supplemented by delivery with a tube trailer 1 and on-site electrolysis with an electrolysis+compression device 2, or by vaporization of the liquefied fuel in the liquefied fuel storage device 9.

The present disclosure will be described in detail through embodiments.

### Embodiment 1

The hybrid refueling station is arranged as above. The discharging end of the low-temperature pressurization device 10 is in communication with the inlet of the vaporization device 11 and the heat exchanger inlet of the temperature management system 6 respectively, and the heat exchanger outlet of the temperature management system 6 is connected to the inlet of the gaseous fuel storage device 3 so as to use low-temperature liquefied fuel to heat-exchange the gaseous fuel. Hydrogen fuel is used in the refueling station, and a total amount of gas refueling is 3000 kg/d, which includes a liquefied fuel supply amount of 2700 kg/d and a gaseous fuel supply amount of 300 kg/d. Data on dispensing cost, capital requirement, boil-off loss of liquefied fuel can be seen in Table 1.

Design benefits of the hybrid refueling station can be illustrated with detailed techno-economic analysis. The US Department of Energy (DOE) Argonne National Laboratory (ANL) has developed such models that have been accepted as the standard. In particular, the Hydrogen Refueling Station Analysis Model (HRSAM) takes such factors as hydrogen refueling station size, refueling profile, rate of return on capital and manufacturing maturity into consideration and produces equipment layout, capital investment requirement and unit dispensing cost.

FIG. 5 shows a dispensing cost as the hybrid refueling station varies in size up to 3000 kg/d. The light line indicates the gaseous hydrogen fuel, and the dark line indicates the liquified hydrogen fuel. The refueling station provides H70 fuel. For a vehicle, a refueling amount each time is 5 kg with a refueling time of 5 minutes and a lingering time of 2 minutes. Up to 8 nozzles are required to fulfill such requirements as the station size increases.

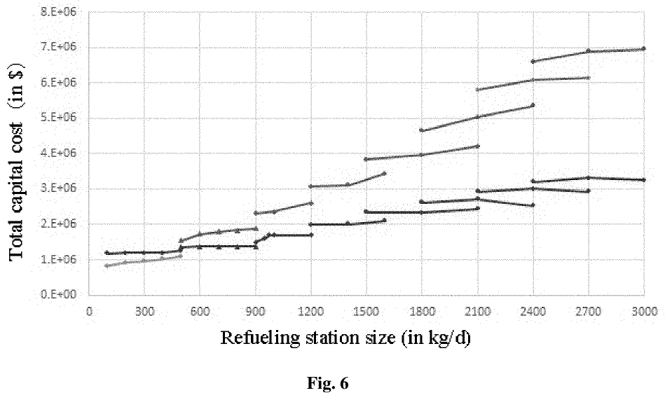

Similarly, FIG. 6 shows a functional relation between a total capital cost (in $) of and a refueling station size (in kg/d) of the hybrid refueling station. The light line indicates the gaseous hydrogen fuel, and the dark line indicates the liquified hydrogen fuel.

### Embodiment 2

The hybrid refueling station is arranged as above. The discharging end of the low-temperature pressurization device 10 is in communication with the inlet of the vaporization device 11 and the heat exchanger inlet of the temperature management system 6 respectively, and the heat exchanger outlet of the temperature management system 6 is connected to the inlet of the second gas storage subunit 5 so as to use low-temperature liquefied fuel to heat-exchange the gaseous fuel.

### Comparative Example 1

A liquefied hydrogen fuel refueling station in the prior art as shown in FIG. 2 is used for a refueling operation. A total amount of gas refueling of the refueling station each day is 3000 kg/d. Data on dispensing cost, capital requirement, boil-off loss of liquefied fuel in the liquefied hydrogen fuel refueling station can be seen in Table 1.

### Comparative Example 2

A gaseous hydrogen refueling station in the prior art as shown in FIG. 1 is used for a refueling operation. A total amount of gas refueling of the refueling station each day is 3000 kg/d. Data on dispensing cost, capital requirement, boil-off loss of liquefied fuel in the gaseous hydrogen refueling station can be seen in Table 1.

TABLE 1

| | Liquefied | Gaseous | |
|---|---|---|---|
| | hydrogen fuel | hydrogen fuel | Hybrid refueling |
| | refueling station | refueling station | station |
| Liquefied | 3000 | 0 | 2700 |
| hydrogen fuel | | | |
| use, kg/d | | | |
| Gaseous | 0 | 3000 | 300 |
| hydrogen fuel | | | |
| use, kg/d | | | |
| Total station | 3000 | 3000 | 3000 |
| capacity, kg/d | | | |
| Dispensing | 1.26 | 2.27 | 1.61 (2700 kg @ |
| cost, $/kg | | | 1.41 and 300 kg @ |
| | | | 3.36) |
| Capital | 3.3 | 6.9 | 4.3 (3.3 + 0.97) |
| requirement, | | | |
| $m | | | |
| Boil-off loss | 30 + boil-off | 0 | 0 |
| from storage | loss from | | |
| tank, kg/d | cryopump | | |
| | precooling | | |

Industry experience suggests that boil-off loss from the liquefied hydrogen fuel storage tank itself is approx. 1% per day, in addition to any boil-off loss associated with cryopump precooling. Therefore the boil-off loss is at least 30 kg/d for a purely liquefied hydrogen fuel station without boil-off loss mitigation. Additional liquefied hydrogen fuel boil-off loss is generated during start-up of the refueling station, and the exact amount varies depending on the refueling schedule for the refueling station; a refueling station with longer gaps between consecutive refueling events will generate larger quantities of liquefied hydrogen fuel boil-off loss. For LDV applications or refueling stations where vehicles arrive in an unscheduled manner, the refueling station will need to be designed to handle the “worst case” scenario to ensure reliability of service. For a purely gaseous hydrogen fuel refueling station, the unit dispensing cost and the capital investment are both much higher, although there is no boil-off loss of fuel. For a purely liquefied hydrogen fuel refueling station, although the benefit of low capital and operating costs is kept, there is boil-off loss of the liquefied hydrogen fuel.

According to the present disclosure, by combining the gaseous hydrogen fuel refueling station with the liquefied hydrogen fuel refueling station, any boil-off fuel from a liquefied hydrogen fuel unit, including natural boil-off loss from the storage tank and boil-off loss caused by cryopump precooling, is recovered into the gaseous fuel storage device, which avoids boil-off loss of the liquefied hydrogen fuel. Besides, during start-up of the liquefied hydrogen fuel unit, a gaseous hydrogen unit is instantly used for hydrogen refueling, which avoids a delay during start-up of the liquefied hydrogen fuel unit. In addition, compared with a purely gaseous hydrogen fuel refueling station, the hybrid refueling station according to the present disclosure has a smaller footprint and a lower cost. The result in the table shows that the hybrid refueling station has no boil-off loss with quick startup, back-to-back refueling, and reasonable capital and dispensing costs.

It should be noted that, the above embodiments are only for explaining the present disclosure, and does not constitute any limitation to the present disclosure. The present disclosure is described with reference to exemplary embodiments, but it should be understood that words used herein are descriptive and explanatory, rather than restrictive. Changes can be made to the present disclosure within the scope of the claims of the present disclosure, and modifications can be made to the present disclosure without departing from the scope and the spirit of the present disclosure. Although specific methods, materials and embodiments of the present disclosure are described herein, it does not mean that the present disclosure is limited to specific embodiments disclosed herein; on the contrary, the present disclosure can be extended to all other methods and applications for the same function.

1. A hybrid refueling station, comprising:
a liquefied fuel unit, which comprises at least one liquefied fuel storage device, a vaporization device and a first gas storage subunit, wherein the liquefied fuel storage device is connected with the first gas storage subunit via the vaporization device, and the first gas storage subunit is used for storing vaporized fuel;
a gaseous fuel unit, which comprises at least one gaseous fuel storage device, a pressurization device and a second gas storage subunit, wherein the gaseous fuel storage device is connected with the second gas storage subunit via the pressurization device, and the second gas storage subunit is used for storing pressurized gaseous fuel;
a temperature management system, which comprises a gas inlet and a gas outlet, wherein the gas inlet is connected to the liquefied fuel unit and the gaseous fuel unit respectively for adjusting a temperature of gas discharged from the liquefied fuel unit and the gaseous fuel unit; and
a dispensing unit, which is connected to the gas outlet of the temperature management system for dispensing gas from the temperature management system,
wherein boil-off fuel from the liquefied fuel unit is recovered to the gaseous fuel unit.

2. The hybrid refueling station according to claim 1, wherein boil-off fuel from the liquefied fuel unit is recovered to the gaseous fuel storage device.

3. The hybrid refueling station according to claim 1, wherein the boil-off fuel comprises boil-off fuel from the liquefied fuel storage device and boil-off fuel during a cryopump precooling.

4. The hybrid refueling station according to claim 1, wherein the temperature management system further comprises a heat exchanger inlet and a heat exchanger outlet, wherein the heat exchanger inlet is connected to the liquefied fuel unit, and the heat exchanger outlet is connected to the gaseous fuel unit.

5. The hybrid refueling station according to claim 4, wherein the heat exchanger outlet is connected to the gaseous fuel storage device or the second gas storage subunit.

6. The hybrid refueling station according to claim 1, wherein the liquefied fuel unit further comprises a low-temperature pressurization device, wherein a feeding end of the low-temperature pressurization device is connected to an outlet of the liquefied fuel storage device, and a discharging end of the low-temperature pressurization device is connected to an inlet of the vaporization device.

7. The hybrid refueling station according to claim 6, wherein the low-temperature pressurization device is a cryopump.

8. The hybrid refueling station according to claim 1, wherein the first gas storage subunit and the second gas storage subunit each are independently selected from the group consisting of a cascade storage tubes or a buffer storage tank.

9. The hybrid refueling station according to claim 1, wherein the temperature management system is a refrigeration device; and/or the dispensing unit comprises a refueling nozzle; and/or the pressurization device is a gas compressor or a cryopump; and/or the vaporization device is a vaporizer.

10. The hybrid refueling station according to claim 9, wherein the temperature management system is selected from the group consisting of a tubular heat exchanger, a coil heat exchanger and a plate heat exchanger.

11. A method for refueling by using the hybrid refueling station according to claim 1, comprising the steps of:
refueling, during start-up of the liquefied fuel unit, by the gaseous fuel unit and recovering boil-off fuel from the liquefied fuel unit to the gaseous fuel unit, wherein the boil-off fuel from the liquefied fuel unit comprises boil-off fuel from the liquefied fuel storage device and boil-off fuel during a cryopump precooling.

12. The method for refueling according to claim 11, wherein recovering boil-off fuel from the liquefied fuel unit to the gaseous fuel storage device.

13. The method for refueling according to claim 11, wherein
the step of refueling by the gaseous fuel unit comprises: performing refueling after subjecting gaseous fuel in the gaseous fuel storage device to pressurization and refrigeration.

14. The method for refueling according to claim 11, wherein the method for refueling further comprises: performing refueling by the gaseous fuel unit or the liquefied fuel unit after start-up of the liquefied fuel unit is finished.

15. The method for refueling according to claim 11, wherein liquefied fuel from the liquefied fuel unit is used to perform refrigeration to the temperature management system.

16. The method for refueling according to claim 11, wherein the fuel is selected from the group consisting of hydrogen, natural gas and propane.

17. The method for refueling according to claim 16, wherein the fuel is hydrogen.
